(19) United States
(12) Patent Application Publication
(10) Pub. No.: US 2007/0168353 A1
(43) Pub. Date: Jul. 19, 2007

(54) User terminal and file list providing method therefor

(75) Inventor: Myung-yul Jang, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/528,587

(22) Filed: Sep. 28, 2006

(30) Foreign Application Priority Data
Jan. 5, 2006 (KR) 2006-1492

(51) Int. Cl. G06F 17/30

(52) U.S. Cl. 707/10

(57) ABSTRACT

A user terminal and a file list providing method therefore, the user terminal having a driver installed to control an image forming apparatus, wherein the driver includes a user interface unit to input a specified folder and a list providing method from a user; a list creation unit to create a list of files in the inputted specified folder; and a control unit to control the created list to be outputted according to the inputted list providing method. Thus, the efficiency of managements on mass storage media can be provided.

### CROSS-REFERENCE TO RELATED APPLICATION

This application claims the benefit under 35 U.S.C. §119 from Korean Patent Application 2006-1492, filed on Jan. 5, 2006 in the Korean Intellectual Property Office, the entire disclosure of which is incorporated herein by reference.

### BACKGROUND OF THE INVENTION

1. Field of the Invention

Aspects of the present invention relate to a user terminal and a file list providing method therefore, and more particularly, to a user terminal and a file list providing method therefore which enables users to easily manage the files stored in a mass storage medium.

2. Description of the Related Art

A user terminal such as a personal computer (PC) is equipped with a certain storage medium for storing various data. The storage medium is mainly classified into a main storage medium and an auxiliary storage medium. The main storage devices applied to a user terminal may include a Read Only Memory (ROM) and a Random Access Memory (RAM). The auxiliary storage device may include a hard disk.

The hard disk is a device for assisting the main storage device, such as ROM and RAM, and is a non-volatile mass memory device having characteristics of the non-volatility of the ROM and the read/write functionality of the RAM. Particularly, the hard disk stores and executes the operating system (OS), which operates the user terminal.

At the time that hard disks were introduced in user terminals, a hard disk having a low write density of 10 MB to 20 MB was used at a low speed. However, the hard disk was further developed to have a 40 MB to 100 MB storage capacity. As such, a user could use a user terminal with this capacity without being inconvenienced. However, as operating systems evolved, becoming more complicated and demanding, and as diverse multimedia contents gained currency, the amount of data to be stored in a hard disk has gradually increased. Accordingly, the capacity of a hard disk has continuously increased, though the physical size of the hard disk has decreased. Today, hard disks of tens of gigabytes are commonly used.

As the capacity of a hard disk and the amount of data stored in a hard disk increases, it becomes very complicated to manage data on the hard disk. Further, since data of diverse types are stored in a hard disk together with more widely spread multimedia contents, it is a difficult task for a user to search for desired data from a high-capacity hard disk.

### SUMMARY OF THE INVENTION

Aspects of the present invention provide a user terminal and a file list providing method therefore, which outputs a file list of a folder that a user desires in the manner that the user wants through a driver of an image forming apparatus.

Additional aspects and/or advantages of the invention will be set forth in part in the description which follows and, in part, will be obvious from the description, or may be learned by practice of the invention.

According to an aspect of the present invention, there is provided a user terminal having a driver installed to control an image forming apparatus, the driver comprising a user interface unit to input from a user a specified folder and a list providing method; a list creation unit to create a list of files in the inputted specified folder; and a control unit to control the created list to be outputted according to the inputted list providing method.

The list creation unit may, but not necessarily, create the list in any of a Hypertext Markup Language (HTML) format or an Extensible Markup Language (XML) format.

The control unit may, although not necessarily, create the list as a file if the list providing method is a store method, and may, although not necessarily, instruct a printout of the list if the list providing method is a print method.

The user terminal may, although not necessarily, further comprise a storage unit to store the created file, wherein the control unit adds modified information to attribute information of the created file if the file is already stored in the storage unit.

The user interface unit may, although not necessarily, input a sorting method for files in the specified folder from the user, and the list creation unit sorts the files according to the inputted sorting method and creates the list.

The user terminal may, although not necessarily, further comprise an image decision unit to decide whether the files in the specified folder are image files; and a thumbnail creation unit to create thumbnails for files decided as image files from the files in the specified folder, wherein the list creation unit links the created thumbnails to corresponding files in the list.

According to another aspect of the present invention, there is provided a file list providing method comprising inputting a specified folder and a list providing method from a user; creating a list of files in the inputted specified folder; and outputting the created list according to the inputted list providing method.

The creating of the list may, although not necessarily, include creating the list in any of an HTML format or an XML format.

The outputting of the created list may, although not necessarily, include creating the list as a file if the list providing method is a store method, and instructing a printout of the list if the list providing method is a print method.

The method may, although not necessarily, further comprise deciding whether there exists the same file as the created file in the files already stored and adding modified information to attribute information of the created file if the list providing method is the store method and there exists the same file.

An input step may, although not necessarily, further include inputting a sorting method for files in a specified folder from a user, and a list creation step can include sorting the files according to an inputted sorting method and creating a list of the files.

The method may, although not necessarily, further comprise deciding whether the files in the specified folder are image files; and creating thumbnails for files decided as image files in the files of the specified folder, wherein the creating of the list can include linking the created thumbnails to corresponding files in the list.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram to show a user terminal according to an embodiment of the present invention;

FIG. 2 is a view to explain the functions of the user interface unit shown in FIG. 1;

FIG. 3 is a view to illustrate a list created on the user terminal of FIG. 1; and

FIG. 4 is a flow chart to show a file list providing method according to aspects of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

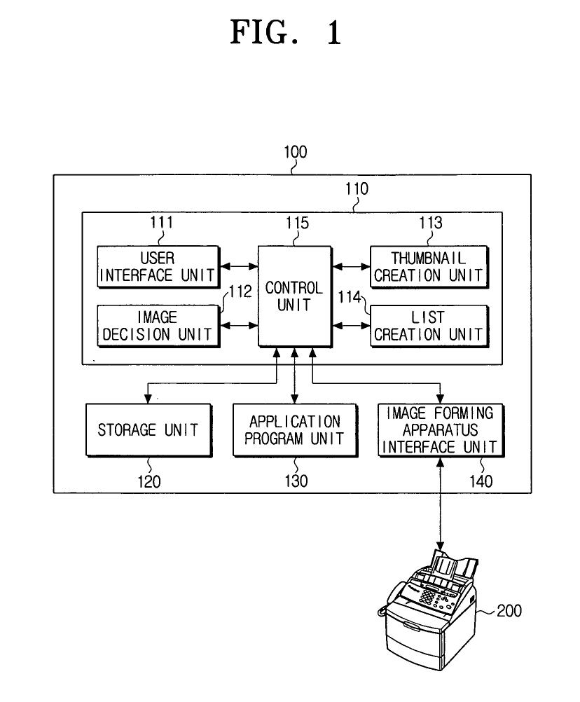

FIG. 1 is a block diagram to show a user terminal according to an embodiment of the invention. In FIG. 1, the user terminal 100 includes a driver 110, a storage unit 120, an application program unit 130, and an image forming apparatus interface unit 140. Further, the user terminal 100 is connected to an image forming apparatus 200 in a certain connection method. For instance, the connection method can be through wired connections, such as through a USB connector, and/or using wireless connections. The image forming apparatus 200 controlled by the driver 110 can be a printer, a scanner, or a multi-function peripheral.

The driver 110 is a program installed in the user terminal 100 to control the image forming apparatus 200. The driver 110 includes a user interface unit 111, an image decision unit 112, a thumbnail creation unit 113, a list creation unit 114, and a control unit 115. However, it is understood that the driver 110 can include other units to control the image forming apparatus 200, such as units to control collating, color, printing, status, etc.

The user interface unit 111 supports an interface between a user and the user terminal 100. That is, the user terminal 100 can receive a certain setting value from the user through the user interface unit 111, and can send through the user interface unit 111 a message. Examples of the message could be alerts or information typically sent by a driver 110.

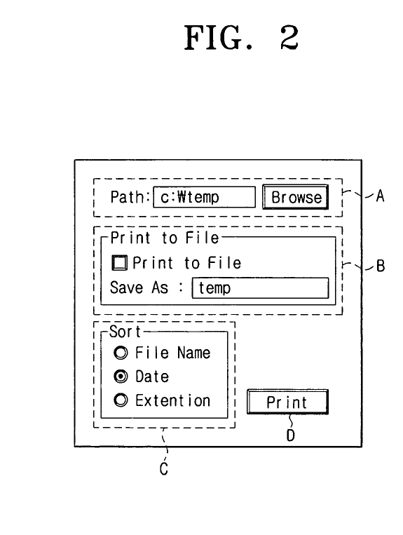

In the shown embodiment, the user interface unit 111 selectively inputs specified folders for creation of a list, a list-providing method, and a file-sorting method from the user. Description of the user interface unit 111 will be made in more detail with reference to FIG. 2.

The image decision unit 112 detects whether files in a specified folder received through the user interface unit 111 are image files or non-image files. The image decision unit 112 may, although not necessarily, decide the files to be image files if the extensions of the files existing in the specified folder are image file extensions (such as JPG, GIF, TIFF) and the like. However, it is understood that the detection can be made otherwise.

The thumbnail creation unit 113 creates thumbnails for files which the image decision unit 112 detects as being image files. The thumbnail represents a small image of an original image in order for users to view or manage many images easily and rapidly, through which the user can easily preview images without memorizing each and every file name.

The list creation unit 114 operates under control of the control unit 115, to be later described, and creates a file list having the attribute information of the files in the specified folder received through the user interface unit 111. In here, the list creation unit 114 can create the list in any of, though not limited to, Hypertext Markup Language (HTML) or Extensible Markup Language (XML) formats by using an open source. However, it is understood that other languages can be used to create the list, and that the language need not be of an open source format.

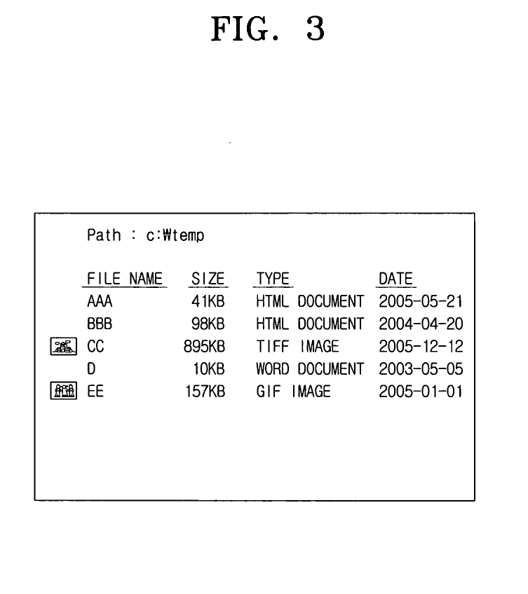

If a specific file is decided by the image decision unit 112 to be an image file upon creation of a list and a thumbnail is created by the thumbnail creation unit 113, the list creation unit 114 links the created thumbnail to the image file. Further, if a user sets a method for sorting files in a specified folder through the user interface unit 111, the list creation unit 114 sorts the files in the specified folder in set sorting method and creates a list. According to an aspect of the invention, the sorting method can include file name order, date order, and size order each of which can be set to an ascending order or a descending order. Description of the list creation unit 114 will be made with reference to FIG. 3.

The control unit 115 controls the overall functions of the driver 110. That is, the control unit 115 controls input and output signals between the user interface unit 111, image decision unit 112, thumbnail creation unit 113, and list creation unit 114. If user's setting values are inputted for a specified folder, a list providing method, and a sorting method through the user interface unit 111, the control unit 115 controls the image decision unit 112 to decide whether there exist image files in the specified folder. Moreover, the control unit 115 controls the thumbnail creation unit 113 to create thumbnails if there are image files.

The control unit 115 controls the list creation unit 114 to create a list of the files in the specified folder. If the image decision unit 112 decides that there exist image files in the specified folder, the control unit 115 controls the list creation unit 114 to create a list linking the thumbnails created by the thumbnail creation unit 113 to corresponding files. Further, when the list creation unit 114 creates the list, the control unit 115 controls the list creation unit 114 to create the list by reflecting the sorting method received through the user interface unit 111.

After the list is created by the list creation unit 114, the control unit 115 controls the list to be created as a file when the list providing method inputted through the user interface unit 111 is a storage method, and/or controls the list to be printed through a certain application program when the list providing method is a print method. If the list created by the list creation unit 114 is created in the HTML format, the control unit 115 may, although not necessarily, control the list to be printed through an internet browsing program, such as Internet Explorer.

After the control unit 115 controls the list to be created as a file, if there exists the same file as the currently created file in the files already stored in the storage unit 120, the control unit 115 adds modified information to the attribute information of the currently created file. The control unit 115 can first decide whether there exists the same file as the currently created file in the stored files, and can add the modified information to the attribute information of the currently created file according to a result of the decision. The control unit 115 can decide whether the stored file is identical to the currently created file by comparing file names.

The storage unit 120 may, although not necessarily, be a hard disk that stores the operating system to drive the user terminal 100 and various drivers and application programs. In the present embodiment, if the control unit 115 controls the list to be created into a file, the storage unit 120 stores the created file.

The application program unit 130 is at least one program installed in the user terminal 100 for creation and browsing of various documents. In the present embodiment, if an HTML-format list is created by the list creation unit 114, the application program unit 130 may be the Microsoft Internet Explorer, though not limited thereto.

The image forming apparatus interface unit 140 supports an interface between the user terminal 100 and the image forming apparatus 200 which are connected in a certain connection method. The user terminal 100 can send a print command and print data to the image forming apparatus 200 through the image forming apparatus interface unit 140. The image forming apparatus 200 can send its state information, such as a print result, to the user terminal 100 through the image forming apparatus interface unit 140. If a list providing method set by a user is a print method and the control unit 115 controls the application program unit 130 to print a list, a print command and the list to be printed is sent to the image forming apparatus 200 through the image forming apparatus interface unit 140.

FIG. 2 is a view to explain the functions of the user interface unit shown in FIG. 1. The driver 110 supports an interface with a user through the user interface unit 111. In general, the user interface unit 111 provided by the driver 110 has various menus to control a file list creation. The user interface unit 111 can be a display integral to or connected to the user terminal 100, and can further include an input mechanism such as a keyboard or touch screen display.

In the shown embodiment, an input window is provided to input a user's setting values needed to create a list including, but not limited to, a specified folder, a list providing method, and a sorting method.

The user interface unit 111 outputs the input window shown in FIG. 2 to receive setting values from the user. Such an input window is outputted by the driver 110, converted into a form displayable on a display device driver (not shown), sent to a display device (not shown) connected to the user terminal 100, and displayed on a screen.

While not restricted thereto, the input window displayed by the user interface unit 111 has a specified folder setting menu A, a list providing method setting menu B, a sorting method setting menu C, and a print button D. However, it is understood that the input window can be otherwise constructed, and can replace the menus with buttons and vice versa.

A user can input various setting values through the input window displayed on the display device. If the “Browse” button is selected in the specified folder setting menu A, folders for creation of a list can be easily found. Alternatively, the path to the folder can be directly input, or automatically detected (such as when a flash drive is connected to the user terminal 100).

In the list providing method setting menu B, the options are set by a user clicking on the check box of “Print to File” if the user wants to store a file list as a file and clicking off the check box of “Print to File” if the user wants to print the file list. Further, if the check box of “Print to File” is clicked on, a file name can be arbitrarily specified, but need not in all aspects. It is understood that the functions can both be performed in other aspects by printing and storing the generated file.

In the sorting method setting menu C, the user can select one of “File Name”, “Date”, or “Extension”. In here, a method of sorting files in file name order, date order, or size order is shown as an example, but a menu can be further provided which enables a user to select an ascending order or a descending order with respect to each sorting option. Also, a menu is not limited to these three sorting options, and may include less or other sorting options.

If a user presses the print button D after setting each setting value through the specified folder setting menu A, list providing method setting menu B, and sorting method setting menu C, the setting values set on the user interface unit 111 are inputted into the control unit 115. Thereafter, the setting values are respectively applied to the operations of the image decision unit 112, the thumbnail creation unit 113, and the list creation unit 114 under control of the control unit 115.

FIG. 3 is a view to show a list created on the user terminal of the present invention. FIG. 3 shows an output of a list created by the list creation unit 114. The output can be an example of a list stored in a file if the list providing method is a store method, or an example of a list printed on a printing paper through the image forming apparatus 200 if the list providing method is a print method.

The list shows the attribute information of the files in a specified folder. The attribute information can contain a file name, size, type, and date, but is not limited thereto. Although not shown, if modified information is added to the attribute information when there exists the same file, the list can further contain the modified information of the currently created file.

Further, the specified folder for creation of a list can contain files in diverse formats, examples of such formats include, but are not limited to, files in HTML format, image files, and Word files. As for image files contained in the list, thumbnails for images are created and linked to front portions of file names so that a user can easily preview the images.

In the list shown in FIG. 3, the files named “CC” and “EE” are files of images in TIFF format and in GIF format, respectively, so the image decision unit 112 decides that the two files are image files. Thus, it can be seen that thumbnails for the respective image are linked to the front portions of the file names of the two files.

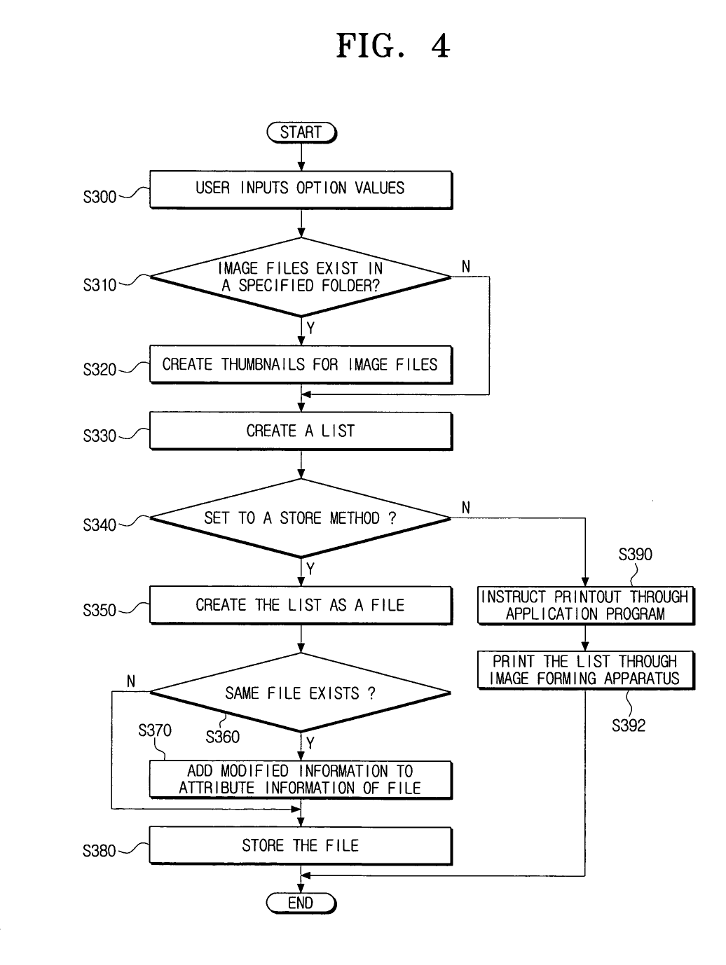

FIG. 4 is a flow chart to show a file list providing method according to aspects of the present invention. The file list providing method of the present invention will be described with reference to FIGS. 1 to 4. If a user intends to print a list of files stored in a specific folder, he or she inputs certain setting values, such as, but not limited to, a specified folder, a list providing method, and a sorting method through the user interface unit 111 provided by the driver 110 (S300).

If certain user's setting values are inputted to the user interface unit 111, the control unit 115 controls the image decision unit 112 to decide whether there exist image files in the inputted specified folder. The image decision unit 112 decides whether there exist image files using the extensions of the file names existing in the specified folder (S310).

In the step S310, if it is decided by the image decision unit 112 that there exist image files in the specified folder, the control unit 115 controls the thumbnail creation unit 113 to create thumbnails. The thumbnail creation unit 113 creates thumbnails for the files decided to be image files by the image decision unit 112 (S320).

If the operations of the image decision unit 112 and the thumbnail creation unit 113 are completed, the control unit 115 controls the list creation unit 114 to create a list of the files in the specified folder. The list creation unit 114 creates the list having attribute information of the files existing in the specified folder set by a user, and, if there are thumbnails created by the thumbnail creation unit 113, the created thumbnails are linked to corresponding files (S330).

If it is decided that there does not exist image files in the specified folder in the step S310, then no thumbnails are created by the thumbnail creation unit 113, the step S320 is skipped, and the list is created by the list creation unit 114 (S330).

Next, the control unit 115 decides whether the list providing method inputted through the user interface unit 111 is set to the store method or the print method (S340). If the control unit 115 decides that the list providing method is set to the store method in the step S340, the list created by the list creation unit 114 is created as a file (S350).

The control unit 115 decides whether there exists the same file as the currently created file in the files already stored in the storage unit 120 (S360), and adds modified information to attribute information of the currently created file when there exists the same file (S370). The file created as above is stored in the storage unit 120 (S380).

If it is decided that the list providing method is set to a print method rather than the storage method in the step S340, the control unit 115 instructs printing through an application program corresponding to the created list format (S390).

If the control unit 115 instructs the printing through the application program, the print command and the list to be printed are sent to the image forming apparatus 200 through the image forming apparatus interface unit 140. After receiving the print command from the user terminal 100, the image forming apparatus 200 carries out a print job of the list (S392).

As described above, the list is outputted in the manner of storage in file if the list providing method is set to the store method, and the list is outputted in the manner of a print job of the list if the print method is set. Therefore, the list of files can be provided in the manner a user wants.

As stated above, the user terminal and the file list providing method according to aspects of the present invention provide a user, in files or printouts, with a list of files in a folder that the user wants through the image forming apparatus driver. Aspects of the present invention provide for easier management of files by simple manipulations on a user terminal having a mass storage medium.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A driver installed in a user terminal, the driver comprising:
a user interface unit to receive an input of a specified folder and a type of list providing method;
a list creation unit to create a list of files in the inputted specified folder; and
a control unit to control the created list to be outputted according to the inputted list providing method, and to control a printing operation of an image forming apparatus.

2. The driver as claimed in claim 1, wherein the list creation unit creates the list in a Hypertext Markup Language (HTML) format and/or an Extensible Markup Language (XML) format.

3. The driver as claimed in claim 1, wherein the control unit creates the list as a file when the list providing method is a store method, and instructs a printout of the list when the list providing method is a print method.

4. The driver as claimed in claim 3, further comprising:
a storage unit to store the created file, wherein the control unit adds modified information to attribute information of the created file when the created file is already stored in the storage unit of the user terminal.

5. The driver as claimed in claim 4, wherein the control unit determines if the created file is already stored by comparing a file name of the created file to a file name of a stored file.

6. The driver as claimed in claim 1, wherein the user interface unit inputs a sorting method of files in the specified folder from a user, and the list creation unit sorts the files according to the inputted sorting method and creates the list.

7. The driver as claimed in claim 6, wherein the user can input a sorting method to sort the files in file name order, date order, size order, or combinations thereof.

8. The driver as claimed in claim 6, wherein the user can input a sorting method to sort the files in an ascending order or a descending order with respect to another sorting method inputted by the user.

9. The driver as claimed in claim 1, wherein the user interface unit provides various menus to a user to input settings of the list of files created by the list creation unit, and the various menus comprise:
a specified folder setting menu to input the specified folder; and
a list providing method setting menu to input the list providing method.

10. The driver as claimed in claim 9, wherein the various menus further comprise a sorting method setting menu to input a sorting method of files in the specified folder.

11. The driver as claimed in claim 1, further comprising:
an image decision unit to decide whether the files in the specified folder are image files; and
a thumbnail creation unit to create thumbnails of files decided as image files in the files of the specified folder, wherein the list creation unit links the created thumbnails to corresponding files in the list.

12. The driver as claimed in claim 11, wherein the image decision unit decides the files in the specified folder to be image files if extensions of the files in the specified folder are image file extensions.

13. A file list providing method, comprising:
inputting a specified folder and a list providing method from a user;
creating a list of files in the inputted specified folder; and
outputting the created list according to the inputted list providing method.

14. The method as claimed in claim 13, wherein the creating of the list comprises creating the list in any of a Hypertext Markup Language (HTML) format and/or a Extensible Markup Language (XML) format.

15. The method as claimed in claim 13, wherein the outputting of the created list comprises creating the list as a file when the list providing method is a store method, and instructing printout of the list when the list providing method is a print method.

16. The method as claimed in claim 15, further comprising adding modified information to attribute information of the created file if the list providing method is the store method and the created file is already stored.

17. The method as claimed in claim 16, further comprising comparing a file name of the created file to a file name of a stored file to determine if the created file is already stored.

18. The method as claimed in claim 13, wherein the inputting of the specified folder comprises inputting a sorting method of files in the specified folder from the user, and the creating of a list comprises sorting the files according to the inputted sorting method and creating the list.

19. The method as claimed in claim 13, further comprising:
deciding whether the files in the specified folder are image files; and
creating thumbnails of files decided as image files in the files of the specified folder, wherein the creating of a list comprises linking the created thumbnails to corresponding files in the list.

20. The method as claimed in claim 19, wherein the deciding of whether the files in the specified folder are image files comprises determining whether extensions of the files in the specified folder are image file extensions.

21. A user terminal comprising:
a storage unit to store files of the user terminal; and
a driver to control a creation and output of a list of files in a specified folder according to an input list providing method for the list, to store the list in the storage unit when the list providing method is a store method, and to control a printing operation of an image forming apparatus.

22. The user terminal as claimed in claim 21, wherein the driver comprises:
a user interface unit to receive an input of the specified folder and a type of the list providing method;
a list creation unit to create the list of the files in the inputted specified folder; and
a control unit to control the created list to be outputted according to the inputted list providing method and to control the printing operation of the image forming apparatus.

23. The user terminal as claimed in claim 22, wherein the list creation unit creates the list in a Hypertext Markup Language (HTML) format and/or an Extensible Markup Language (XML) format.

24. The user terminal as claimed in claim 22, wherein the control unit creates the list as a file and stores the file in the storage unit when the list providing method is the store method, and instructs a printout of the list when the list providing method is a print method.

25. The user terminal as claimed in claim 24, wherein the control unit adds modified information to attribute information of the created file if the created file is already stored in the storage unit.

26. The user terminal as claimed in claim 25, wherein the control unit determines if the created file is already stored by comparing a file name of the created file to a file name of a stored file.

27. The user terminal as claimed in claim 22, wherein the user interface unit inputs a sorting method of files in the specified folder, and the list creation unit sorts the files according to the inputted sorting method and creates the list.

28. The user terminal as claimed in claim 27, wherein the sorting method is selectable between sorting the files in file name order, date order, size order, or combinations thereof.

29. The user terminal as claimed in claim 27, wherein the sorting method is selectable between sorting the files in an ascending order or a descending order with respect to another sorting method inputted by the user.

30. The user terminal as claimed in claim 22, wherein the user interface unit provides various menus to input settings of the list of files created by the list creation unit, and the various menus comprise:
a specified folder setting menu to input the specified folder; and
a list providing method setting menu to input the list providing method.

31. The user terminal as claimed in claim 30, wherein the various menus further comprise a sorting method setting menu to input a sorting method of files in the specified folder.

32. The user terminal as claimed in claim 22, further comprising:
an image decision unit to decide whether the files in the specified folder are image files; and
a thumbnail creation unit to create thumbnails of files decided as image files in the files of the specified folder, wherein the list creation unit links the created thumbnails to corresponding files in the list.

33. The user terminal as claimed in claim 32, wherein the image decision unit decides the files in the specified folder to be image files if extensions of the files in the specified folder are image file extensions.

34. The user terminal as claimed in claim 21, further comprising an image forming apparatus interface unit to support an interface between the user terminal and an image forming apparatus which are connected, wherein the driver instructs the image forming apparatus, through the image forming apparatus interface unit, to print the list if the list providing method is a print method.

35. A computer readable medium encoded with processing instructions for implementing the file list providing method of claim 13 performed by one or more computers.
